(19) United States
(12) Patent Application Publication
(10) Pub. No.: US 2007/0255816 A1
(43) Pub. Date: Nov. 1, 2007

(54) SYSTEM AND METHOD FOR PROCESSING DATA SIGNALS

(76) Inventors: Schuyler Quackenbush, Westfield, NJ (US); Thomas Darcie, Victoria (CA); Larry Ruedisueli, Berkley Heights, NJ (US); Neil Barakat, Victoria (CA); Peter Driessen, Sidney (CA)

Correspondence Address: RAYMOND R. MOSER JR., ESQ.;MOSER IP LAW GROUP, 1040 BROAD STREET, 2ND FLOOR, SHREWSBURY, NJ, 07702, US

(21) Appl. No.: 11/740,794

(22) Filed: Apr. 26, 2007

Related U.S. Application Data
(60) Provisional application No. 60/796,396, filed on May 1, 2006.
(60) Provisional application No. 60/886,510, filed on Jan. 25, 2007.
(60) Provisional application No. 60/886,723, filed on Jan. 26, 2007.
(60) Provisional application No. 60/887,784, filed on Feb. 1, 2007.
(60) Provisional application No. 60/892,810, filed on Mar. 2, 2007.

(51) Int. Cl. G06F 15/173

(52) U.S. Cl. 709/223

(57) ABSTRACT

Embodiments of the present invention relate to a system and method for processing data signals in real-time via a global computer network. More specifically, embodiments of the present invention relate to a system and method for processing data signals comprising a first data signal received from a first client, a second data signal received from a second client, a mixer for mixing the first and second data signals, a first unique data mix, for the first client, generated by the mixer, and a second unique data mix, for the second client, generated by the mixer. Additional embodiments of the invention further provide a system comprising a first unique data mix is exclusive of the first data signal, and a second unique data mix is exclusive of the second data signal.

### CROSS-REFERENCE TO RELATED APPLICATIONS

This application claims the benefit of U.S. Provisional Application Ser. No. 60/796,396, entitled “System and Method for Transmitting Audio Signals”, filed May 1, 2006, the disclosure of which is incorporated herein by reference in its entirety. This application also claims the benefit of U.S. Provisional Application Ser. No. 60/886,510, filed Jan. 25, 2007; U.S. Provisional Application Ser. No. 60/886,723, filed Jan. 26, 2007; U.S. Provisional Application Ser. No. 60/887,784, filed Feb. 1, 2007; and U.S. Provisional Application Ser. No. 60/892,810, filed Mar. 2, 2007; the disclosures of which are incorporated herein by reference in their entirety.

### BACKGROUND OF THE INVENTION

1. Field of the Invention

Embodiments of the present invention generally relate to a system and method for processing data signals. More specifically, embodiments of the present invention relate to a system and method for processing data signals in real-time via a global computer network.

2. Description of the Related Art

There has been a recent increase in musicians' interest to create a musical work without the need to assemble all musicians in one recording studio. One option is for musicians to collaborate via a global computer network to create a musical work. In the past, audio signals from different musicians, vocalists or other audio sources would be recorded individually at one location, transmitted to a central location, and later mixed together to form the musical work. The musical work could then be transmitted back to the musicians. However, this activity could not be performed in real-time or substantially real-time, and issues such as lack of interactivity and/or timing made the musical work difficult to mix, record, and produce.

Similar systems to form remote collaborative musical works required program servers to interface with a global computer network, and allow multiple musicians at different locations to send a MIDI audio stream to the server. The server would then mix the audio sources using a MIDI merge function and feed the merged MIDI signal back to participating musicians. This can also be done in a peer-to-peer manner, bypassing a network server and having each musician's computer mix the streams received from all other users. However, this system often could not provide live feedback to the musicians during their performance, and did not support the broad set of non-MIDI instruments and vocals.

Realizing these issues, certain systems and methods were developed to allow for near real-time music collaboration via a global computer network. For example, U.S. Pat. No. 6,898,637, issued May 24, 2005 to Curtin, discloses a method and apparatus that allows multiple musicians at various locations to collaborate on a musical work and provide near real-time feedback of the collaborative work to the musicians. The system disclosed in Curtin provides a server and a plurality of musicians/clients. An audio signal is generated by each of the clients and transmitted to the server, where the each of the signals are mixed together and transmitted back, as a collaborative work, to all of the musicians/clients. As a result, each of the musicians receive, and can listen to, an audio mix of all the individual audio signals in near real-time.

However, the system disclosed in Curtin creates a new set of issues for real-time data collaboration via a global computer network. For example, Curtin teaches that each musician receives the collaborated work comprising all of the individual audio signals, including the musician's own audio signal. As a result, a musician (e.g., an electric guitarist) is playing an instrument and likely hearing the instrument as it is being played. However, due to a time lag in the signal transmission, the musician is receiving the collaborative work moments later. Thus, an undesirable echoing effect likely occurs as the musician hears the signal from her/his own instrument moments after it was heard in the first instance. Additionally, each musician must listen to the same mix of all others, and cannot adjust the mix to suit individual preference or maximize creative composition.

Thus, there is a need for an improved system and method for processing data signals in real-time via a global computer network.

### SUMMARY OF THE INVENTION

Embodiments of the present invention relate to a system for processing data signals comprising a first data signal received from a first client, a second data signal received from a second client, a mixer for mixing the first and second data signals, a first unique data mix, for the first client, generated by the mixer, and a second unique data mix, for the second client, generated by the mixer. Additional embodiments of the invention further provide a system comprising a first unique data mix that is exclusive of the first data signal, and a second unique data mix that is exclusive of the second data signal.

Additional embodiments of the present invention relate to a method of transmitting real-time multimedia data signals via a global computer network comprising generating a plurality of multimedia data signals from a plurality of clients, transmitting the plurality of multimedia data signals to a server-located mixer, creating a plurality of unique multimedia data mixes, and transmitting the plurality of unique multimedia data mixes to the plurality of clients, wherein an individual unique multimedia data mix transmitted to an individual client is exclusive of the multimedia data signal generated by the individual client.

Other embodiments of the present invention relate to a computer readable medium comprising a computer program having executable code, the computer program for enabling real-time multimedia data mixing, the computer program comprising instructions for receiving a first data signal from a first client at a mixer, receiving a second data signal from a second client at the mixer, creating a first unique mix and a second unique mix, sending the first unique mix to the first client; and sending the second unique mix to the second client.

### BRIEF DESCRIPTION OF THE DRAWINGS

So the manner in which the above recited features of the present invention can be understood in detail, a more particular description of embodiments of the present invention, briefly summarized above, may be had by reference to embodiments, several of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of a general computer system in accordance with one embodiment of the present invention;

FIG. 2 depicts a block diagram of a system in accordance with one embodiment of the present invention;

FIG. 3 depicts a block diagram of a system in accordance with one embodiment of the present invention;

FIG. 4 depicts a flow chart of a method of processing data signals in accordance with one embodiment of the present invention; and

FIG. 5 depicts a block diagram of a system in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

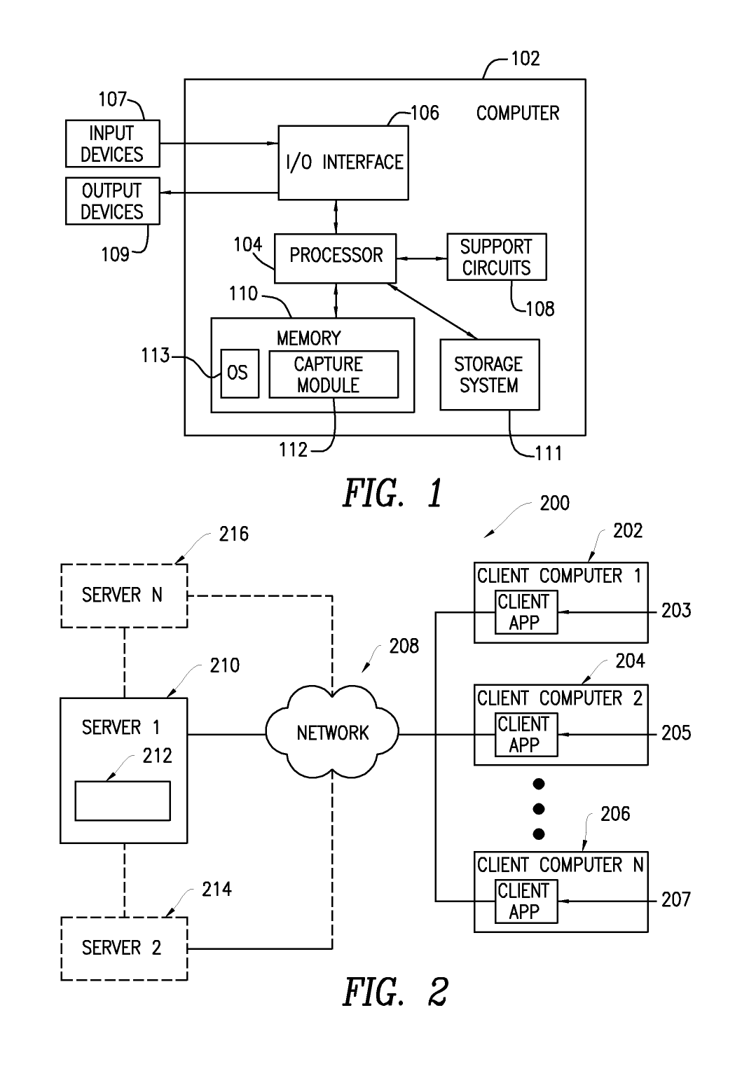

FIG. 1 depicts a block diagram of a general computer system in accordance with one embodiment of the present invention. The computer system 100 generally comprises a computer 102. The computer 102 illustratively comprises a processor 104, a memory 110, various support circuits 108, an I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

FIG. 2 depicts a block diagram of a system in accordance with one embodiment of the present invention. The system 200 generally comprises a first client computer 202, a second client computer 204, and additional client computers, up to client computer N 206, where N represents any number of client computers practical for operation of embodiments of the present invention. The system 200 further includes a network 208, a server 210, a mixer 212, and optionally a plurality of N additional servers (e.g., 214 & 216). The network 208 may be any network suitable for embodiments of the present invention, including, but not limited to, a global computer network, an internal network, local-area networks, wireless networks, and the like.

The first client computer 202 comprises a client application 203. The client application 203 is generally software or a similar computer-readable medium capable of at least enabling the first client computer 202 to connect to the proper network 208. In one embodiment, the client application 203 is software, commercially available by Lightspeed Audio Labs of Tinton Falls, N.J. In another embodiment, the client application 203 further provides instructions for various inputs (not shown), both analog and digital, and also provides instructions for various outputs (not shown), including a speaker monitor (not shown) or other output device. The second client computer 204 and client computer N 206 also comprise respective client applications (205, 207).

The server 210 may be any type of server, suitable for embodiments of the present invention. In one embodiment, the server 210 is a network-based server located at some remote destination (i.e., a remote server). In other embodiments, the server 210 may be hosted by one or more of the client computers. Additional embodiments of the present invention provide the server 210 is located at an internet service provider or other provider and is capable of handling the transmission of multiple clients at any given time.

The server 210 may also comprise a server application (not shown). The server application may comprise software or a similar computer-readable medium capable of at least allowing clients to connect to a proper network. In one embodiment, the server application is software, commercially available by Lightspeed Audio Labs of Tinton Falls, N.J. Optionally, the server application may comprise instructions for receiving data signals from a plurality of clients, compiling the data signals according to unique parameters, and the like.

The mixer 212 may be any mixing device capable of mixing, merging, or combining a plurality of data signals at any one instance. In one embodiment, the mixer is a generic computer, as depicted in FIG. 1. In another embodiment, the mixer 212 is capable of mixing a plurality of data signals, in accordance with a plurality of different mixing parameters, resulting in various unique mixes. The mixer 212 is generally located at the server 210 in accordance with some embodiments of the present invention. Alternative embodiments provide the mixer 212 located at a client computer, independent of server location.

As is understood by one of ordinary skill in the art, multiple servers may be the most efficient methods of communication between multiple clients when particular constraints exist. In one embodiment, multiple servers are provided to support multiple clients in a particular session. For example, in one embodiment, a group of three clients are connected through a first server 210 for a first session. A group of five clients want to engage in a second session, but the first server 210 is near capacity. The group of five clients are then connected through the second server 214 to allow for a session to take place.

For example, in another embodiment, a server 210 hosting a mixer 212 is provided in a system 200. As the server 210 becomes congested with multiple client transmissions, it may be beneficial to allow some of the clients to pass through a second server 214, thus relieving the bandwidth on the server 210. The second server 214 and first server 210 may be connected to one another through the network and/or any other known communication means to provide the most efficient methods of communication. If necessary, additional server N 216, where N represents any number of servers practical for operation of embodiments of the present invention, may be utilized as well.

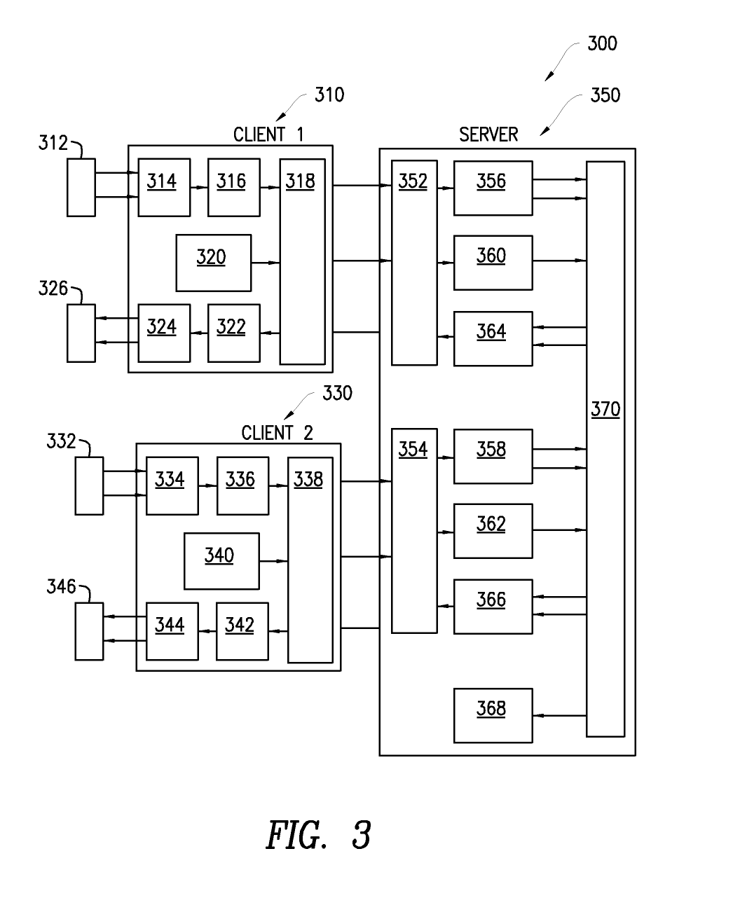

FIG. 3 depicts a block diagram of a system in accordance with one embodiment of the present invention. The system 300 generally comprises at least a first client 310, a second client 330, and a server 350. Optionally, a plurality of additional clients (not shown) or servers (not shown) may be provided without deviating from the structure of embodiments of the present invention.

In one embodiment, the first client 310 comprises an input device 312, an output device 326, and an interface 318 for connecting to the server 350. The first client 310 may also comprise an input sample rate converter 314, audio encoder 316, audio decoder with error mitigation 322, and output sample rate converter 324. Optionally, the first client 310 comprises a mix controller 320 having a graphical user interface.

The input device 312 comprises at least one of any musical instrument (e.g., guitar, drums, bass, microphones, and the like), other live or pre-recorded audio data (e.g., digital audio, compact disc, cassette, streaming radio, live concert, voice(s)/vocal(s), and the like), live or pre-recorded visual data, (e.g., webcam, pre-recorded video, and the like), other multimedia data, and the like. The output device 326 comprises at least one of headphones, speaker(s), video monitor, recording device (e.g., CD/DVD burner, digital sound recorder, and the like), means for feeding to other location, and the like.

The second client 330 similarly comprises an input device 332, an output device 346, an interface 338 for communicating with the server 350, an input sample rate converter 334, audio encoder 336, audio decoder with error mitigation 342, and output sample rate converter 344. Optionally, the second client 330 comprises a mix controller 340 having a graphical user interface. The input device 332 and output device 346 are substantially similar to the first client input device 312 and output device 332, respectively.

The server 350 generally comprises a first interface 352 for communicating with the first client 310, a second interface 354 for communicating with the second client 330, and a mixer 370. The server 350 may also comprise a first and second audio decoder with error mitigation 356, 358, a first and second controller for processing mix parameter instructions 360, 362, a first and second audio encoder 364, 366, and a status console 368. The status console 368 provides a visual and/or audio indication of the status of the system 300, at any given time during operation.

The mixer 370 is provided to perform the mix of multiple client data signals into single, stereo, or multi-channel signals (e.g., 5.1 Channel Sound). For audio signals, a mix is generally understood as the addition or blending of wave forms. The mixer 370 generally comprises a plurality of input and output channels, equal to at least the number of clients communicating with the server 350 at any given time.

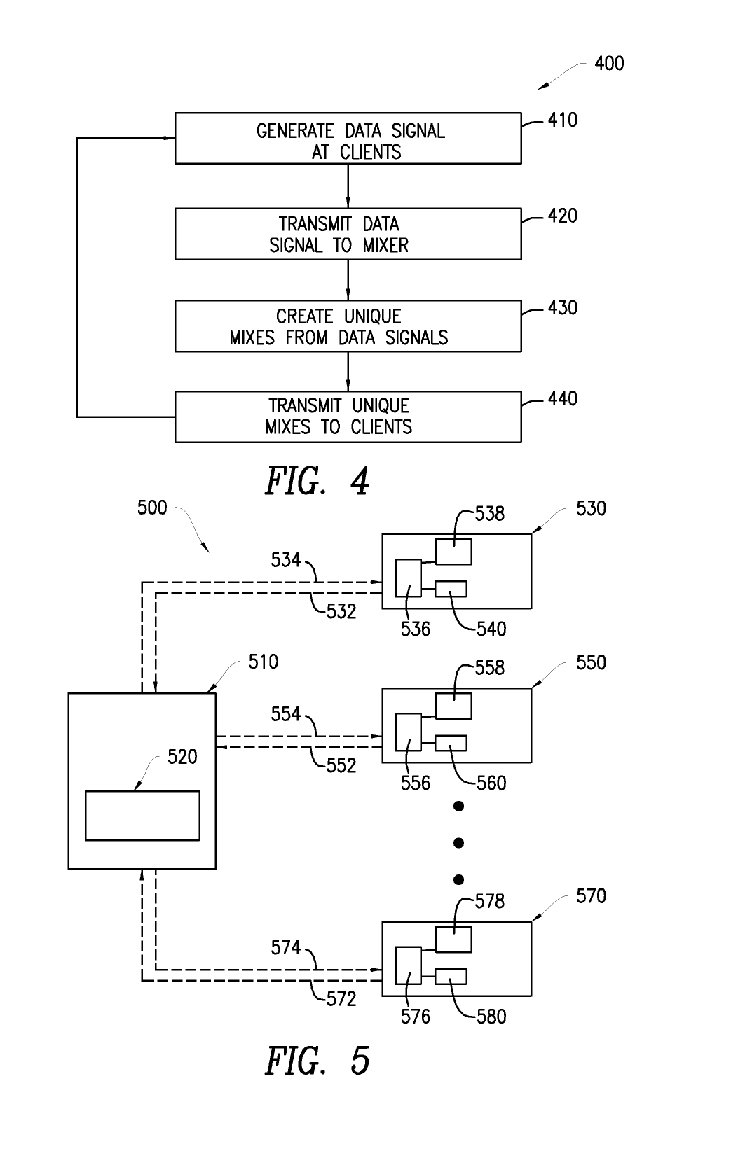

FIG. 4 depicts a flow chart of a method of processing data signals in accordance with one embodiment of the present invention. The method 400 is described with respect to the system 300 disclosed in FIG. 3. All descriptions of processes occurring at any one client described herein are intended by embodiments of the present invention to be applicable to any or all additional clients.

The method 400 is understood by embodiments of the present invention to occur in “real-time”. Real-time is known in the industry as near-instantaneous, subject to minor delays caused by network transmission and computer processing functions, and able to support various input and output data streams.

The method 400 begins at Step 410 as a plurality of data signals are generated from the input devices 312, 332 at the respective clients 310, 330. In one embodiment, the data signals comprise a plurality of audible sounds from various musical instruments. Other embodiments provide the data signals may comprise any variation or sampling of multimedia data.

At Step 420, the data signals are transmitted to the mixer 370, located at the server 350, via standard communication methods. To accomplish this step, the data signal is first collected by the respective client, e.g., 310, via the input device 312. The data is passed through a sample rate converter 314, which accommodates and accounts for the asynchronous timing of each client's respective internal clocks (not shown).

From the sample rate converter 314, the data is passed through an audio encoder 316 where it is compressed for efficient transmission to the server 350. In one embodiment, the encoding is performed using a block-processing algorithm, whereby the data is buffered at a predetermined duration, which is then capable of being transmitted as a packet or block.

The transmission from the client 310 to the server 350 occurs through the respective interfaces 318, 352. The interfaces 318, 352 may be capable of handling any known transmission protocols including TCP/IP and/or UDP. Other plausible transmission protocols include FTP, ATM, Frame relay, Ethernet, and the like. Once received at the server 350, the data is passed through an audio decoder 356 with error mitigation, where the data is decompressed for mixing by the mixer 370. The error mitigation allows for correction or otherwise fixing, filling, or skipping any data packet errors, for example, late packets, otherwise unavailable packets, or any other transmission or data error that may occur.

If error mitigation is necessary, for example, due to packet loss, the audio decoder 356 will implement an error concealment strategy. Error concealment strategies may include repetition of a previous packet, linear estimation of the missing packet (based on earlier packet and subsequent packet data), model-based estimation of the missing packet, inserting a zero packet (i.e., the effect of estimating the data as zero), and the like. In one embodiment, an error concealment strategy comprises performing a linear predictive estimation in the frequency domain of a missing data packet. By performing the linear predictive estimation in the frequency domain, an accurate approximation is generally obtained.

At Step 430, the data signal is sent to the mixer 370 where it is mixed with data signals sent from other clients, to create a unique mix or plurality of unique mixes. A unique mix is a mix created for an individual client, based on specific mixing instructions from the client. Embodiments of the present invention provide that if a number of clients N are connected to a server in any given session, at least N number of unique mixes may be created during that session.

The mixing instructions to create a unique mix for a client 310 may be set by the client 310. In one embodiment, the mix controller 320 having a graphical user interface provides the client 310 the ability to manipulate the unique mix for the client 310. The mix controller 320 communicates with the mixer via the respective interfaces 318, 352 and the controller for processing mix parameter instructions 360.

The mix controller 320 may control the gain/level, balance/pan, equalization, reverb, tone, and/ordynamics of each individual data signal sent to the mixer 370. In several embodiments of the present invention, the mix controller 320 may control any aspect of an individual multimedia signal that may be processed through a standard channel strip. For example, in one embodiment, there may be a guitarist, vocalist, drummer, and bassist sending data signals to the mixer in a session, all from different client locations. The guitarist may want to only hear the drummer and bassist, and may manipulate the data signals entering her/his unique mix by altering the gain levels on the mix controller. Similarly, the drummer may want all data signals present, but have the bass only on a right-channel output, and have the vocals louder than the guitar. The drummer could manipulate the data signals accordingly, and receive her/his unique mix. By providing every client with a mix controller, each client may receive a unique mix desirable to that client.

In one embodiment of the present invention, the unique mix of every client is defaulted to exclude the clients' own data signal. By excluding the clients' own data signal, the individual at the client will avoid hearing an echo of the individuals own voice. While embodiments of the present invention provide a real-time method and system of processing such data, slight delay may be noticeable to the client, even if the delay is on the order of 10 ms or less, in some cases. Thus, an individual, e.g., a vocalist, who can hear her/his own voice while singing or speaking, will not want to hear her/his voice in the respective unique mix.

However, if the client desires to receive his/her own generated data signal in the unique mix, the data signal may be re-inserted at the client, just prior to the output device. For example, if an individual at the client is playing an electronic keyboard, the individual may not be able to hear the output from the keyboard itself as the individual is playing. In such a situation, it would be desirable to place the client's data signal in the unique mix received by that client. In one embodiment, the client's own data signal is re-inserted in the unique mix at the client, such that the time delay between generating the data signal and producing the signal at the output is minimal.

A depiction of continuous, real-time data flow between client and mixer is shown in FIG. 5. The system 500 is provided with a first client 530, a second client 550, a third client 570, and a server 510 hosting a mixer 520. The first client 530 is provided with a client computer 536, an input device 538, and an output device 540. The input device 538 may be any device capable of producing a multimedia signal. For example, in one embodiment, the input device 538 is a guitar. Other exemplary input devices include microphone, piano, drums, other acoustic and/or electronic instruments, and the like. Similarly, the second client 550 and the third client 570 are provided with respective client computers 556, 576, input devices 558, 578, and output devices 560, 580.

Via the first client's computer 536, a multimedia signal 532 from the input device 538 may be transmitted to the mixer 520 at the server 510. Similarly, the second client 550 provides a multimedia signal 552 to the mixer 520. The third client 570 also provides a multimedia signal 572 to the mixer 520. Thus, in the embodiment depicted in FIG. 5, the mixer 520 receives three independent multimedia signals 532, 552, 572.

In real-time, unique mix data is being sent to each of the respective clients from the mixer 520. In one embodiment, each unique mix from the mixer 520 is different than any other unique mix. Thus, the unique mix 534 to the first client 530 is different than the unique mix 554 to the second client 550, which is different than the unique mix 574 to the third client 570. In another embodiment, each unique mix differs from another by omitting the respective client's own multimedia data from that client's unique mix. For example, the unique mix 534 for the first client 530 may only comprise a mix of the multimedia data from the second client 550 and the third client 570. Similarly, the unique mix 554 to the second client 550 may only comprise a mix of the multimedia data from the first client 530 and third client 570. And, the unique mix 574 to the third client 570 may only comprise a mix of the multimedia signals from the first client 530 and second client 550.

Returning to FIG. 4, at Step 440, the unique mixes are transmitted back to the respective clients. The unique mixes are sent from the mixer 370 to the audio encoder 364 where the unique mix data is compressed for transmission back to the client. The unique mix data is transmitted from the server interface 352 to the client interface 318. Upon receipt at the client 310, the unique mix data passes through the audio decoder 322 with error mitigation. Similar to the server audio decoder 356, the client audio decoder 322 may implement error concealment strategies if a data packet error occurs.

The decompressed unique mix data is passed through a sample rate converter 324 to account for the asynchronous timing of the client's internal clock and the server 350. From the sample rate converter 324, the data is sent to the output device 326. The client 310 may further modify the unique mix through external devices (e.g., secondary mixer, speaker volume, etc.).

While method 400 is generally explained above with reference to audio signals, it is understood by embodiments of the present invention that method 400 is equally applicable to any multimedia data signals, including audio, video, and the like.

Alternative embodiments of the present invention generally incorporate the structure and method described in the embodiments above, with minor additions and/or modifications. The following embodiments may be considered independently or in combination with any other embodiment contained herein.

In one embodiment, a memory and/or recording device (not shown) is provided with the mixer. The memory may store each individual data signal from every client in a given session to form an archive, such that the individual data signals are available in the archive for retrieval at a later time. Thus, a client or a producer may later retrieve each of the individual data signals and re-mix the signals to obtain a professional or record-quality collaborative work. In yet another embodiment, a client may utilize the mix controller, located at the client, to manipulate the individual data signals of an archived session.

In another embodiment, the recording device can be updated with additional information not available during the creation of the real-time mix. For example, the archive can request re-transmission from the clients of packets that are lost, received with errors, or otherwise unusable. Packets that do arrive, but arrive too late to be included in the real-time mix, can be added to the archive. In this manner, the archived information can be higher quality than that in the original mixes.

In another embodiment, two streams of multimedia data are encoded by a client during any data transmission. A first layer, known as the base layer, is utilized in the real-time mixing of the multimedia signals. A second layer, known as the enhancement layer, may be optionally added to the base layer to enhance the quality of the base layer. The enhancement layer may be added into an archive over the base layer, such that later retrieval of the multimedia data signals consists of both the base layer and enhancement layer.

In another embodiment, each client comprises a distinct sound card with an independent audio sampling clock, having a potential error with respect to a nominal, virtual sampling frequency. Thus, the client encoder and decoder utilize fractional sample rate conversion to create a virtual sampling clock, nearly identical for all clients. The server sends information to the clients that permit the client's virtual sampling clock to be equal to a single nominal clock value. However, the local error in sampling for each client, with respect to the nominal sampling frequency, must be bounded to minimize overflow and underflow from the buffer.

In another embodiment, the server stores an archive of the client signals. The use of an archive, having a sample rate converter, overcomes the issues with overflow and underflow, as the multimedia data will be stored in the appropriate manner despite any transmission lag of individual data packets or different sampling clocks of the client signals. Thus, the correctly reconstructed mix is available for later retrieval.

In another embodiment, the mixer generally mixes together all multimedia data that are represented from one time instant (usually time-stamped by a virtual sampling clock). Often, clients form respective multimedia data signals into frames in an asynchronous manner, and there may be as much as one-half frame duration error in time alignment when the mixer is mixing the data signals. To overcome this issue, the clients frame the input signals beginning at the same instant by utilizing a virtual sampling frequency, and virtual frame-boundary signal, and the time alignment error is minimized.

In another embodiment, the server collects encoded blocks from the various clients in an input buffer, and the clients collect encoded blocks from the server in an output buffer, during a real-time session. Such buffers are generally referred to as jitter buffers. The buffer size is directly correlated to the round-trip delay within the system, i.e., the larger the buffer size, the larger the delay. However, an increase in buffer size is also correlated to a lower likelihood of an individual packet unavailability when it is needed. Thus, the system dynamically adjusts the size of these buffers such that a low probability of packet error is maintained, resulting in an optimum tradeoff between real-time transmission delay and audio quality.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

We claim:

1. A system for processing data signals comprising:
a first data signal received from a first client;
a second data signal received from a second client;
a mixer for mixing the first and second data signals;
a first unique data mix, for the first client, generated by the mixer; and
a second unique data mix, for the second client, generated by the mixer.

2. The system of claim 1, wherein the first unique data mix is exclusive of the first data signal; and wherein the second unique data mix is exclusive of the second data signal.

3. The system of claim 1, wherein the mixer is located at a remote-server location.

4. The system of claim 1, further comprising:
a recorder for recording the first data signal and second data signal.

5. The system of claim 4, further comprising:
A third unique data mix, created from the first data signal and second data signal.

6. The system of claim 5, wherein the third unique data mix comprises an enhanced data signal from at least one client; and wherein the first unique data mix and second unique data mix are exclusive of the enhanced data signal.

7. The system of claim 1, wherein the first data signal and second data signal comprise multimedia data.

8. The system of claim 7, wherein the multimedia data comprises at least one of audio data or video data.

9. The system of claim 1, further comprising:
a mixing controller for controlling at least the first unique data mix, located at the first client.

10. A method of processing data signals comprising:
generating a first data signal from a first client;
generating a second data signal from a second client;
transmitting the first and second data signals to a mixer;
creating a first unique mix and a second unique mix;
sending the first unique mix to the first client; and
sending the second unique mix to the second client.

11. The method of claim 10, wherein the first unique mix is exclusive of the first data signal; and wherein the second unique mix is exclusive of the second data signal.

12. The method of claim 10 further comprising:
recording the first data signal and second data signal.

13. The method of claim 12, further comprising:
retrieving the first data signal and second data signal; and
creating a third unique mix from the first data signal and second data signal.

14. The method of claim 10, wherein the first data signal and second data signal comprise multimedia data.

15. The method of claim 14, wherein the multimedia data comprises at least audio data or video data.

16. The method of claim 10, further comprising:
controlling at least the first unique data mix via a mixer controller located at the first client.

17. A method of transmitting real-time multimedia data signals via a global computer network comprising:
generating a plurality of multimedia data signals from a plurality of clients;
transmitting the plurality of multimedia data signals to a server-located mixer;
creating a plurality of unique multimedia data mixes; and
transmitting the plurality of unique multimedia data mixes to the plurality of clients;
wherein an individual unique multimedia data mix transmitted to an individual client is exclusive of the multimedia data signal generated by the individual client.

18. The method of claim 17, wherein the multimedia data signals comprise at least one of audio data or video data.

19. The method of claim 17 further comprising:
recording the plurality of multimedia data signals.

20. The method of claim 19, further comprising:
retrieving the recorded plurality of multimedia data signals; and
creating at least a unique mix from the recorded plurality of multimedia data signals.

21. A computer readable medium comprising a computer program having executable code, the computer program for enabling real-time multimedia data mixing, the computer program comprising instructions for:
receiving a first data signal from a first client at a mixer;
receiving a second data signal from a second client at the mixer;
creating a first unique mix and a second unique mix;
sending the first unique mix to the first client; and
sending the second unique mix to the second client.

22. The computer readable medium of claim 21, wherein the first unique mix is exclusive of the first data signal; and wherein the second unique mix is exclusive of the second data signal.

23. The computer readable medium of claim 21, the computer program further comprising instructions for:
recording the first data signal and second data signal.

24. The computer readable medium of claim 21, wherein the first data signal and second data signal comprise multimedia data.

25. The computer readable medium of claim 24, wherein the multimedia data comprises at least audio data or video data.
